(19) United States
(12) Patent Application Publication
(10) Pub. No.: US 2016/0028791 A1
(43) Pub. Date: Jan. 28, 2016

(54) METHODS FOR EVALUATION OF ITEMS AND SERVICES ON THE INTERNET AND DEVICES THEREOF

(71) Applicant: TOHTT SERVIÇOS DE TECNOLOGIA LTDA., Recife-PE (BR)

(72) Inventor: Tarcísio de Meira Lins FILHO, Rio de Janeiro (BR)

(21) Appl. No.: 14/338,071

(22) Filed: Jul. 22, 2014

(51) Int. Cl. H04L 29/08; G06F 3/0482; G06F 3/0484; G06F 3/0481

(52) U.S. Cl. CPC H04L 67/025; G06F 3/04817; G06F 3/0482; G06F 3/04842; H04L 67/16

(57) ABSTRACT

The present invention is related to the evaluation of items or services on the Internet in web pages, social networks or applications running in mobile devices. In such context, the present invention provides a method, non-transitory computer readable medium, and an evaluation management computing device capable of allowing an unsatisfied user to evaluate a given item or service with a negative classification represented by a trash bin icon. Additionally, the method of evaluation of the present invention is capable of informing whether a certain item or service received any trash bin classification, and in the affirmative, how many users evaluated the same with that classification.

### FIELD

The present invention is related to the evaluation of items or services on the Internet. More particularly, the present invention is related to methods and devices for the evaluation of items or services on the Internet such as web pages, social networks or applications running in mobile devices.

### BACKGROUND

Nowadays the evaluation of items and services in Internet pages and applications is increasingly common. The evaluation may be conducted on the Internet pages of the manufacturer or merchant of a given product or service, such as virtual shops, in websites specializing in the evaluation of services and products, in social networks, in Smartphone applications, among others.

The most common visual means for evaluation of items and services on the Internet is the use of a star-based classification (star rating). FIGS. 1 and 2 show different visual entities for evaluation that make use of stars for evaluations on the Internet. As may be noted, as a rule, such evaluations comprise a rating of 1 to 5 for evaluation of the item or service, where 1 is the lower classification and 5 is the highest classification, corresponding, for example, to an item or a service of extremely bad and of excellent quality, respectively.

That same Internet page or application may provide, as shown in FIG. 3, a summary of the evaluations comprising, for example, an average of the ratings attributed by all users. In this manner, a user that is interested in acquiring a given item or service is able to check the number of users that evaluated the same and the average rating thereof.

However, it often occurs that the user is so unsatisfied with the item or service that he or she wishes to evaluate the same with a rating lower than 1. To date, this type of evaluation with the lowest possible rating still entails a positive meaning, to wit, 1 star. However, based on the possibility of use of the present invention, there will exist an icon that will really express the total lack of any positive characteristic in the item or service that is evaluated. At such time, the user will have the option of expressing his or her total lack of satisfaction.

### SUMMARY

A first object of the invention is to allow a user to express his or her lack of satisfaction with regard to a product or service in an objective manner, by means of an icon that clearly evidences such lack of satisfaction.

A second object of the invention is to provide an evaluation method capable of clearly informing the number of positive and negative evaluations. To this end, a negative icon, represented as a trash bin, will be lit only when the evaluated item will have been the object of a negative evaluation, and will also inform the number of “trash bins” attributed thereto. Therefore, if the trash bin is not lit, it will be obvious that the said item did not receive any negative evaluation.

A method for evaluation of items and services on the Internet comprises providing, by an evaluation management computing device, a plurality of rating options to at least one user to evaluate an item or a service, wherein a lowest classification of the plurality of rating options is displayed as a trash bin icon. A selection of one of the provided plurality of rating options from a plurality of users is received by the evaluation management computing device. A rating attributed to the item or service by the plurality of users is computed by the evaluation management computing device based on the received selections.

An evaluation management computing device includes a processor coupled to a memory and configured to execute programmed instructions stored in the memory including providing a plurality of rating options to at least one user to evaluate an item or a service, wherein a lowest classification of the plurality of rating options is displayed as a trash bin icon. A selection of one of the provided plurality of rating options from a plurality of users is received. A rating attributed to the item or service by the plurality of users is computed based on the received selections.

The present technology provides an evaluation that allows users to rate a lowest classification with a trash bin icon. The present technology allows an item or service to be ranked with a negative classification represented by a trash bin icon, in case that the user deems the item or service to be so bad as to not even deserve at least one star. Thus, the present technology provides an evaluation method with a form of negative evaluation, where no star is associated with the service, there being instead an icon that represents a very negative classification. The technology allows users to provide a more assertive evaluation and provides more details to consumers based on the evaluations.

### BRIEF DESCRIPTION OF THE DRAWINGS

The detailed description that follows makes reference to the attached figures, wherein:

FIG. 1 shows a first star rating for evaluations of items and services as known in the prior art;

FIG. 2 shows a second star rating for evaluations of items and services as known in the prior art;

FIG. 3 shows a general average of evaluations for a star rating as known in the prior art;

FIG. 4 is a block diagram of an environment with an exemplary evaluation computing device;

FIG. 5 is a flowchart of an exemplary method for the evaluation of items or services on the Internet;

FIG. 6 shows a visual interface of the evaluation screen of the method according to a preferred embodiment of the present invention in a Smartphone;

FIG. 7 shows a visual interface of the general average of evaluations screen according to the preferred embodiment of the present invention in a Smartphone.

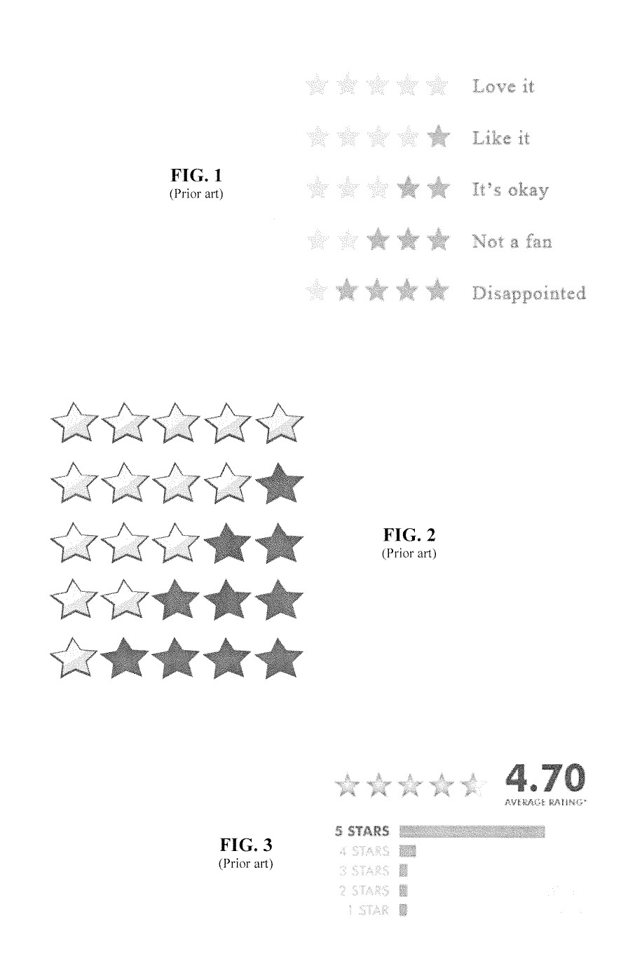

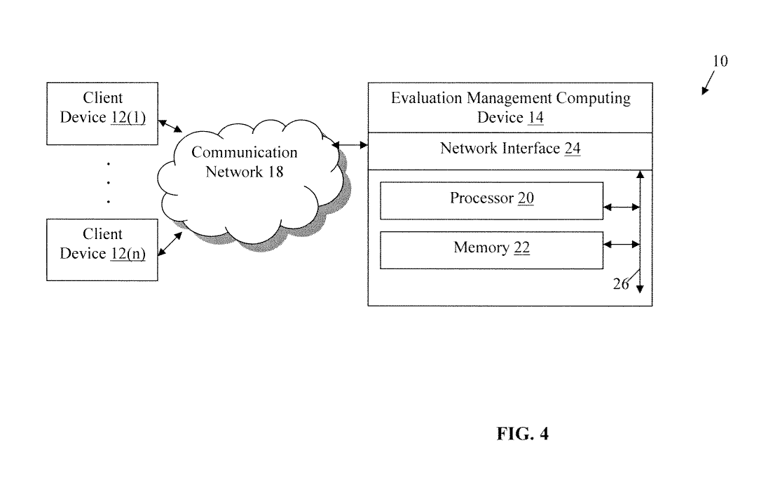

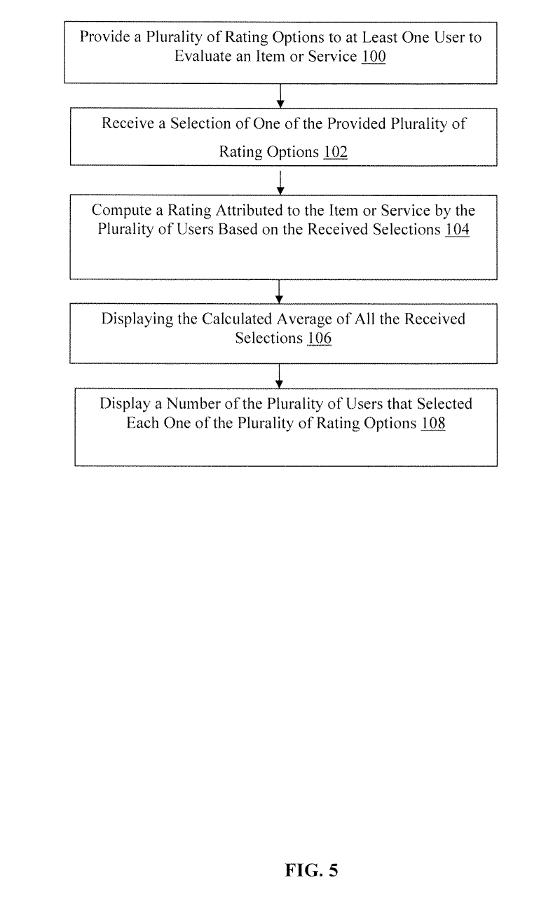

### DETAILED DESCRIPTION

The description that follows will be based on a preferred embodiment of the invention. As will be obvious to any technician skilled in the art, however, the invention is not limited to such particular embodiment.

An environment 10 with an exemplary evaluation management computing device 14 is illustrated in FIG. 4. In this example, the environment 10 includes client devices 12(1)-12(n) and the evaluation management computing device 14, which are coupled by communication network 18, although the environment could include other types and numbers of systems, devices, components, and/or other elements in other configurations and environments with other communication network topologies. This technology provides a number of advantages including providing methods, non-transitory computer readable mediums, and devices for the evaluation of items or services on the Internet.

Referring more specifically to FIG. 4, the client devices 12(1)-12(n) enable a user to request and receive information from at least the evaluation management computing device 14 for the evaluation of items or services on the Internet as illustrated and described with the examples herein, although the client devices 12(1)-12(n) could perform other types and numbers of functions and other operations. By way of example only, the client devices 12(1)-12(n) may comprise computing devices configured to communicate with the evaluation management computing device 14 to obtain content, such as one or more web pages or dashboard interfaces, stored at the evaluation management computing device 14 and/or to send information to the evaluation management computing device 14.

The client devices 12(1)-12(n) include at least one processor, a memory, a user input device, a display, and a network interface, which are coupled together by a bus or other link, although one or more of client devices 12(1)-12(n) can include other numbers and types of components, parts, devices, systems, and elements in other configurations. The processor in each of the client devices 12(1)-12(n) can execute programmed instructions stored in the memory of each of the client devices 12(1)-12(n) for one or more aspects of the present invention as described and illustrated herein, although the processors could execute other numbers and types of programmed instructions.

The memory in each of the client devices 12(1)-12(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in the client devices 12(1)-12(n).

The user input device in each of the client devices 12(1)-12(n) can be used to input selections, such as a request for content or information from the evaluation management computing device 14, although the user input devices could be used to input other types of requests and data. The user input devices can include keypads or touch screens although other types and numbers of user input devices can be used. The display in each of the client devices 12(1)-12(n) can be used to show data and information to the user, such as a dashboard interface, in response to a request for the information from the evaluation management computing device 14. The network interface in each of the client devices 12(1)-12(n) can be used to operatively couple and communicate between the client devices 12(1)-12(n) and at least the evaluation management computing device 14 via the communication network 18.

The evaluation management computing device 14 includes at least one processor 20, a memory 22, and a network interface 24, which are coupled together by a bus 26 or other link, although other numbers and types of components, parts, devices, systems, and elements in other configurations and locations can be used. The processor 20 in the evaluation management computing device 14 executes a program of stored instructions for one or more aspects of the present invention as described and illustrated by way of the embodiments herein, although the processor 20 could execute other numbers and types of programmed instructions.

The memory 22 in the evaluation management computing device 14 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 20, can be used for the memory 22 in the evaluation management computing device 14.

The network interface 24 in the evaluation management computing device 14 is used to operatively couple and communicate between the evaluation management computing device 14 and the client devices 12(1)-12(n) via the communication network 18, although other types and numbers of communication networks 18 with other types and numbers of connections and configurations can be used. Additionally, the communication network 18 can include one or more local area networks (LANs) and/or wide area networks (WANs). By way of example only, the communication networks can use TCP/IP over Ethernet and industry-standard protocols, including hypertext transfer protocol (HTTP) and/or secure HTTP (HTTPS), for example, although other types and numbers of communication networks also can be used.

Although embodiments of the evaluation management computing device 14 and the client devices 12(1)-12(n), are described and illustrated herein, each of the evaluation management computing device 14 and the client devices 12(1)-12(n) can be implemented on any suitable computer apparatus or computing device. It is to be understood that the apparatuses and devices of the embodiments described herein are for exemplary purposes, as many variations of the specific hardware and software used to implement the embodiments are possible, as will be appreciated by those skilled in the relevant art(s).

Furthermore, each of the devices of the embodiments may be conveniently implemented using one or more general purpose computers, microprocessors, digital signal processors, and micro-controllers, programmed according to the teachings of the embodiments, as described and illustrated herein, and as will be appreciated by those ordinary skill in the art.

The embodiments may also be embodied as one or more non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

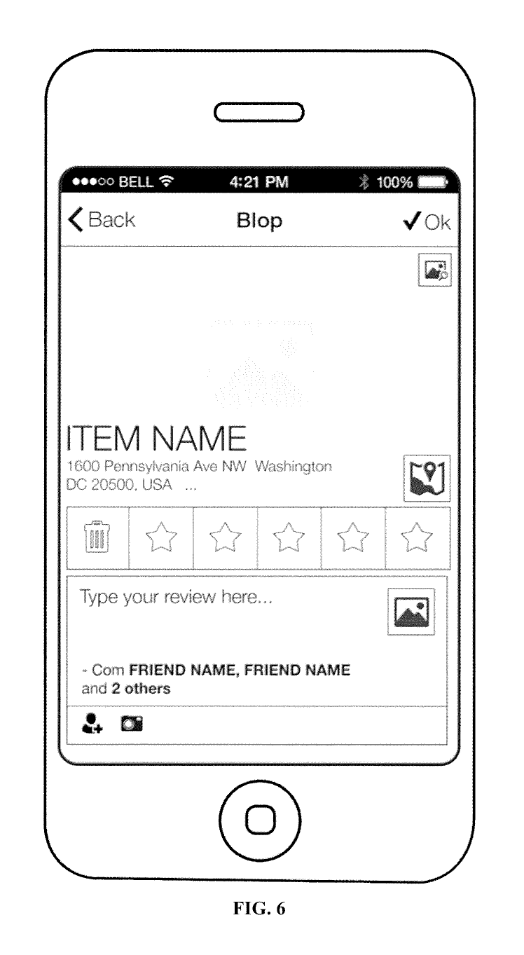

An example of a method for evaluation of items or services on the Internet will now be described with reference to FIGS. 4-7. Referring more specifically to FIG. 5, an exemplary method for the evaluation of items or services on the Internet is illustrated. In step 100, the evaluation management computing device 14 provides a plurality of ratings options to at least one user at one or more of the client devices 12(1)-12(n) to evaluate an item or service. The plurality of ratings options may be displayed by one or more icons on the display interfaces of the client devices 12(1)-12(n). The lowest classification of the plurality of rating options is displayed as a trash bin icon, although the lowest classification may be displayed by other icons providing a negative connotation. As shown in FIG. 6, in one example, the possible ratings options are a trash bin icon, 1 star, 2 stars, 3 stars, 4 stars and 5 stars, although other ratings options may be utilized.

Next, in step 102, the evaluation management computing device 14 receives a selection of one of the provided plurality of ratings options for a plurality of users utilizing client devices 12(1)-12(n). In one example, when a user selects the 2-star rating, for example, two stars light up and 3 stars and the trash bin icon remain unlit. In this example, when the trash bin icon is selected, the trash bin lights up and all the stars remain unlit.

In step 104, the evaluation management computing device 14 computes a rating attributed to the item or service by the plurality of users based on the received selections in step 102. In one example, the step of computing the ratings attributed by each of the users comprises the count of all the votes given by the users and the generation of a general average (general rating). Each of the plurality of rating options may be assigned a numerical value. The rating average may be calculated, for example, as a simple arithmetic average of the numerical values of the received selections, with a trash bin selection having a value equal to 0 (zero), the first star having a value equal to 1 and so on, up to the fifth star that has a value equal to 5. Thus, if a product or service is attributed a trash bin classification and a 4-star rating, its general average will be 2 stars.

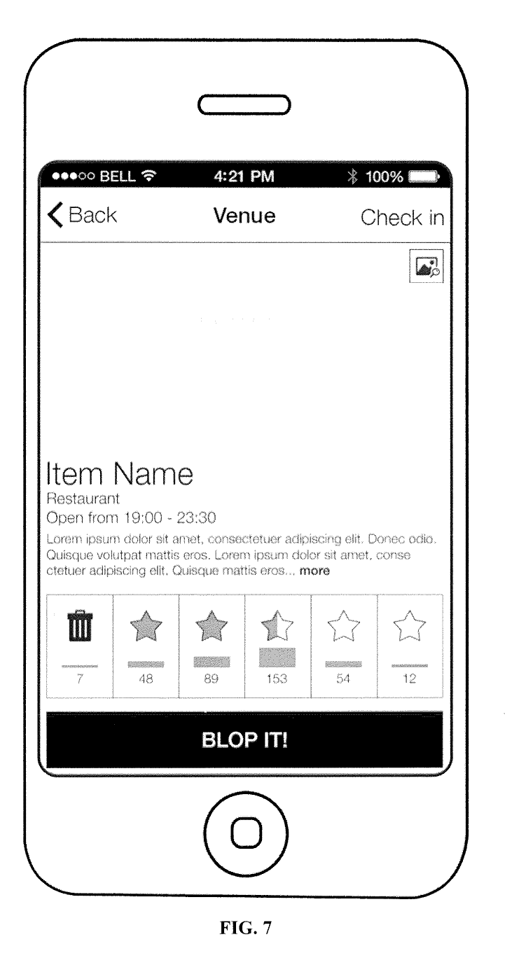

Next, in step 106, the evaluation management computing device 14 displays the calculated average of all the received selections on the display interface of the computing devices 12(1)-12(n). As shown in FIG. 7, the general rating computed in step 104 may be displayed as shading on the star icons. On visualizing the general rating (FIG. 7) associated to the evaluation of an item or service, the trash bin will only be lit if there was at least one trash bin vote for that item or service. Otherwise, only the stars corresponding to the rating having been given will be lit.

Optionally, in step 108, as shown in FIG. 7, the evaluation management computing device 14 displays the number of users that voted for each of the classifications, trash bin and stars on the display interface of the computing devices 12(1)-12(n). Thus, on observing the average of the ratings attributed to a certain item or service, a user is also able to know the number of users that voted for each of those ratings. Thereby, the present invention provides two forms of visualization of, and information on, the evaluation of that product or service, either by knowing the number of individual votes for each rating, or by the general average generated from those votes.

It is important to point out that, on viewing the general average, although only the stars corresponding to that average are lit, the trash bin icon will however be lit, even if it only received 1 vote. This is due to the importance and the strength represented by this icon as a negative factor for a product or service, and any user should be able to clearly, easily and immediately visualize that someone evaluated that product or service with an absolute value. In other words, the image of a trash bin will be sufficient to leave a clear negative message implied by that icon.

Therefore, the present invention allows users to evaluate a given item or service in a very assertive manner in Internet websites or applications.

The present invention may be applied in an infinite number of devices, such as smart phones, tablets, and laptops. Furthermore, the method of the present invention may be applied in any Internet pages.

Accordingly, as illustrated and described with the examples herein this technology provides an improved method and devices for the evaluation of items and services on the Internet. The present technology provides an evaluation that allows users to rate a lowest classification with a trash bin icon. The present technology allows an item or service to be ranked with a negative classification represented by a trash bin icon, in case that the user deems the item or service to be so bad as to not even deserve at least one star. Thus, the present technology provides an evaluation method with a form of negative evaluation, where no star is associated with the service, there being instead an icon that represents a very negative classification. It will be worth pointing out that it often happens that the feeling of dissatisfaction of a user is so intense that a star would constitute too high a classification, since in spite of being only one, the star icon is associated with a positive meaning Therefore, the trash bin icon clearly expresses, with a single image, the feeling of the user with regard to the item being evaluated, without need of further explanations, classifications, or 1 to 5 ratings. Accordingly, with this technology, the evaluation of items and services over the Internet is improved to provide a more accurate assessment and evaluation of the items and services and to provide a higher level of feedback regarding the item or service.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for the evaluation of items or services on the Internet, said method comprising:
providing, by an evaluation management computing device, a plurality of rating options to at least one user to evaluate an item or a service, wherein a lowest classification of the plurality of rating options is displayed as a trash bin icon;
receiving, by the evaluation management computing device, a selection of one of the provided plurality of rating options from a plurality of users; and
computing, by the computing device, a rating attributed to the item or service by the plurality of users based on the received selections.

2. The method as set forth in claim 1, wherein each of the plurality of rating options is assigned a numerical value.

3. The method as set forth in claim 2, wherein the lowest classification is assigned a numerical value of zero.

4. The method as set forth in claim 3, wherein the computing further comprises calculating an average of all the received selections.

5. The method as set forth in claim 4 further comprising:
displaying, by the evaluation management computing device, the calculated average of all the received selections.

6. The method as set forth in claim 1, further comprising:
displaying, by the evaluation management computing device, a number of the plurality of users that selected each one of the plurality of rating options.

7. The method as set forth in claim 6, wherein the displaying the number of the plurality of users that selected each one of the plurality of rating options further comprises displaying the trash bin icon in a highlighted state when at least one selection of the lowest classification of the plurality of rating options is received.

8. An evaluation management computing device comprising:
a memory; and
a processor coupled to the memory, the processor configured to execute programmed instructions stored in the memory comprising:
providing a plurality of rating options to at least one user to evaluate an item or a service, wherein a lowest classification of the plurality of rating options is displayed as a trash bin icon;
receiving a selection of one of the provided plurality of rating options from a plurality of users; and
computing a rating attributed to the item or service by the plurality of users based on the received selections.

9. The device as set forth in claim 8, wherein each of the plurality of rating options is assigned a numerical value.

10. The device as set forth in claim 9, wherein the lowest classification is assigned a numerical value of zero.

11. The device as set forth in claim 10, wherein the computing further comprises calculating an average of all the received selections.

12. The device as set forth in claim 11, wherein the processor is configured to execute programmed instructions stored in the memory further comprising:
displaying, by the computing device, the calculated average of all the received selections.

13. The device as set forth in claim 8, wherein the processor is configured to execute programmed instructions stored in the memory further comprising:
displaying, by the computing device, a number of the plurality of users that selected each one of the plurality of rating options.

14. The device as set forth in claim 13, wherein the displaying the number of the plurality of users that selected each one of the plurality of rating options further comprises displaying the trash bin icon in a highlighted state when at least one selection of the lowest classification of the plurality of rating options is received.

15. A non-transitory computer readable medium having stored thereon instructions for the evaluation of items or services on the Internet comprising machine executable code which when executed by a processor, causes the processor to perform steps comprising:
providing a plurality of rating options to at least one user to evaluate an item or a service, wherein a lowest classification of the plurality of rating options is displayed as a trash bin icon;
receiving a selection of one of the provided plurality of rating options from a plurality of users; and
computing a rating attributed to the item or service by the plurality of users based on the received selections.

16. The medium as set forth in claim 15, wherein each of the plurality of rating options is assigned a numerical value.

17. The medium as set forth in claim 16, wherein the lowest classification is assigned a numerical value of zero.

18. The medium as set forth in claim 17, wherein the computing further comprises calculating an average of all the received selections.

19. The medium as set forth in claim 18, wherein the processor is configured to execute programmed instructions stored in the memory further comprising:
displaying, by the computing device, the calculated average of all the received selections.

20. The medium as set forth in claim 15, wherein the processor is configured to execute programmed instructions stored in the memory further comprising:
displaying, by the computing device, a number of the plurality of users that selected each one of the plurality of rating options.

21. The medium as set forth in claim 20, wherein the displaying the number of the plurality of users that selected each one of the plurality of rating options further comprises displaying the trash bin icon in a highlighted state when at least one selection of the lowest classification of the plurality of rating options is received.
